(19) United States
(12) Patent Application Publication
(10) Pub. No.: US 2025/0091646 A1
(43) Pub. Date: Mar. 20, 2025

(54) STAMPED ENERGY ABSORPTION SIDE STRUCTURE FOR VEHICLE

(71) Applicant: Atieva, Inc., Newark, CA (US)

(72) Inventors: Andrew Charles Nisbet, Menlo Park, CA (US); Subhojit Chakraborty, Hayward, CA (US); Daniel Jefferson Muir, Ben Lomond, CA (US); Mehdi Golozar, San Francisco, CA (US); Kevin Miron, Palo Alto, CA (US)

(21) Appl. No.: 18/557,482

(22) PCT Filed: Oct. 28, 2022
(86) PCT No.: PCT/US2022/078873

§ 371 Date: Oct. 26, 2023

(51) Int. Cl. B62D 21/15; B62D 25/02; C22C 21/00; C22C 21/02; C22C 21/08

(52) U.S. Cl. CPC B62D 21/157; B62D 25/025; C22C 21/00; C22C 21/02; C22C 21/08

(57) ABSTRACT

An energy absorption side structure for a vehicle comprises: a first stamped panel having a series of first ridges each extending substantially perpendicular to a longitudinal axis of the first stamped panel; and a second stamped panel assembled to the first stamped panel to form an enclosed space extending substantially an entire length of the longitudinal axis; wherein the energy absorption side structure is configured for attachment to backup structure of the vehicle.

### TECHNICAL FIELD

This document relates to a stamped energy absorption side structure for a vehicle.

### BACKGROUND

Modern vehicle designs are influenced by the increasing emphasis on vehicle crash safety that characterizes today's automotive manufacturing industry. For protection against side impacts on a vehicle, some different energy absorption mechanisms have been used. With the arrival of electric vehicles, protection of a battery pack positioned underneath the vehicle body also has become an important goal. Previous approaches in vehicle side impact protection have sometimes been based on extruded material such as aluminum. However, an extrusion process provides a rail with a constant profile that may not be adapted to tune the impact protection or conform to the particular design of the vehicle body.

### SUMMARY

In a first aspect, an energy absorption side structure for a vehicle comprises: a first stamped panel having a series of first ridges each extending substantially perpendicular to a longitudinal axis of the first stamped panel; and a second stamped panel assembled to the first stamped panel to form an enclosed space extending substantially an entire length of the longitudinal axis; wherein the energy absorption side structure is configured for attachment to backup structure of the vehicle.

Implementations can include any or all of the following features. Each of the first and second stamped panels includes a hot-stamped aluminum alloy. The hot-stamped aluminum alloy includes: about 0.40-1.00% Mn, about 0.0-0.50% Fe, about 0.60-1.20% Mg, about 0.70-1.30% Si, about 0.0-0.10% Cu, about 0.0-0.20% Zn, about 0.0-0.10% Ti, about 0.0-0.25% Cr, about 0.0-0.15% residual material(s), and a balance of aluminum. Each of the series of first ridges is configured for axial crushing along a longitudinal axis of the respective first ridge. The backup structure comprises a first backup structure for the first stamped panel, and a second backup structure for the second stamped panel, and wherein the first backup structure is different from the second backup structure. The backup structure further comprises a sill extrusion, wherein each of the first and second stamped panels is configured for attachment to the sill extrusion, and wherein the sill extrusion is configured for attachment to the first and second backup structures. The first stamped panel has a flange abutting the backup structure. The second backup structure has a flange abutting the backup structure. The energy absorption side structure has a front end and a rear end with regard to the vehicle, and wherein the enclosed space has a greater height at the rear end than at the front end. At least a first group of the series of first ridges have heights different from each other. The first group of the series of first ridges is positioned ahead of a center of gravity of the vehicle, and wherein the heights of the first group of the series of first ridges increase toward the center of gravity. The first group of the series of first ridges is aligned with a front door opening of the vehicle. A second group of the series of first ridges is aligned with a rear door opening of the vehicle. Each of the series of first ridges is wedge shaped, and wherein the second group of the series of first ridges has steeper inclines than the first group of the series of first ridges. The first group of the series of first ridges are separated from each other by intermediate-height areas, each of the intermediate-height areas having a greater height than a lowest-height section of the first stamped panel. The lowest-height section is aligned with a B-pillar of the vehicle. The second stamped panel has a series of second ridges each extending substantially perpendicular to a longitudinal axis of the second stamped panel. Each of the series of second ridges has a different shape than the series of first ridges. The first stamped panel includes a flange that is substantially parallel with the backup structure and extends on an outboard side substantially along an entire length of the first stamped panel, and wherein each of the first ridges terminates before the flange. The energy absorption side structure further comprises an intermediate stamped panel positioned between the first and second stamped panels in the enclosed space. The intermediate stamped panel has a series of second ridges each extending substantially perpendicular to a longitudinal axis of the intermediate stamped panel. The second ridges are substantially identical to at least some of the first ridges. The intermediate stamped panel is positioned so that one of the first ridges is positioned directly between two of the second ridges. The first stamped panel further comprises a wedge-shaped ridge at a front end of the first stamped panel with regard to the vehicle, the wedge-shaped ridge extending substantially parallel to the longitudinal axis of the first stamped panel, and wherein the wedge-shaped ridge has a narrower end proximate the front end and a wider end distal to the front end.

In a second aspect, a vehicle comprises: a vehicle body providing a backup structure; and an energy absorption side structure comprising: a first stamped panel having a series of first ridges each extending substantially perpendicular to a longitudinal axis of the first stamped panel; and a second stamped panel assembled to the first stamped panel to form an enclosed space extending substantially an entire length of the longitudinal axis; wherein the backup structure supports the energy absorption side structure.

Implementations can include any or all of the following features. The vehicle further comprises a sill extrusion, wherein each of the first and second stamped panels is configured for attachment to the sill extrusion, and wherein the sill extrusion is configured for attachment to the backup structure. The backup structure comprises a first backup structure for the first stamped panel, and a second backup structure for the second stamped panel, and wherein the first backup structure is different from the second backup structure. The first backup structure comprises a floor structure of the vehicle. The second backup structure comprises a battery pack of the vehicle.

### BRIEF DESCRIPTION OF DRAWINGS

FIG. 1 shows an example of an energy absorption side structure for a vehicle including stamped panels.

FIGS. 2-3 show examples of one of the stamped panels of the energy absorption side structure of FIG. 1.

FIG. 4 partially shows an example of a vehicle body with the energy absorption side structure of FIG. 1.

FIG. 5 shows an example cross section of the energy absorption side structure of FIG. 1.

FIG. 6 shows an example of an intermediate stamped panel.

FIG. 7 shows a partial cross section of an example of the intermediate stamped panel of FIG. 6 positioned between the stamped panels of the energy absorption side structure of FIG. 1.

FIG. 8 shows a partial view of an example of the energy absorption side structure of FIG. 1 attached to the sill extrusion and the midfloor extrusion of FIG. 5.

Like reference symbols in the various drawings indicate like elements.

### DETAILED DESCRIPTION

This document describes examples of systems and techniques providing improved energy absorption side structures for vehicles. In some implementations, the energy absorption side structure can be made using hot-stamped aluminum panels. For example, this can provide side impact protection while improving the use of packaging volume and reducing the mass of the vehicle body. Using the present disclosure, the stiffness of the energy absorption side structure can be tuned in one or more regards. For example, the stiffness can be tuned relative to a backup structure in the vehicle that supports the energy absorption side structure, and/or relative to a center of gravity of the vehicle.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger compartment accommodating one or more persons.

Examples described herein refer to a top, bottom, front, side, or rear. These and similar expressions identify things or aspects in a relative way based on an express or arbitrary notion of perspective. That is, these terms are illustrative only, used for purposes of explanation, and do not necessarily indicate the only possible position, direction, and so on.

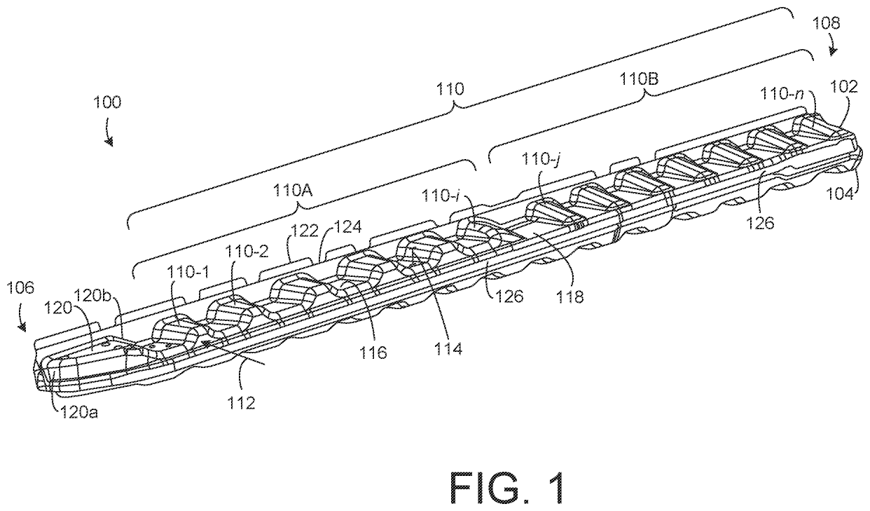

FIG. 1 shows an example of an energy absorption side structure 100 for a vehicle including stamped panels. The energy absorption side structure 100 can be used with one or more other examples described elsewhere herein. The energy absorption side structure 100 includes a stamped panel 102 and a stamped panel 104. The stamped panel 104 is assembled to the stamped panel 102 to form an enclosed space.

The energy absorption side structure 100 has a longitudinal axis that extends between a front end 106 and a rear end 108. The energy absorption side structure 100 can be configured to be mounted on the side of the vehicle so that the front end 106 is closer to a front of the vehicle, and so that the rear end 108 is closer to a rear end of the vehicle. For example, the energy absorption side structure 100 is designed to be mounted to the left side of the vehicle and a corresponding energy absorption side structure, with a corresponding shape, can be designed to be mounted to the right side of the vehicle.

Each of the stamped panels 102 and 104 can be made by applying a hot-stamping process to stock material. In some implementations, the hot-stamping process can involve a higher-temperature stage that occurs for about 10-14 minutes during which the panel is formed (stamped), and a pre-aging stage that occurs for at least about 70-80 minutes. The higher-temperature stage can include about 2-6 minutes at a highest temperature (e.g., about 540-550 degrees Celsius) and an in-die quenching stage down from the highest temperature shorter than the time at the highest temperature. The pre-aging stage can optionally begin with a stage of natural aging without applied heat for less than about 10 minutes. The pre-aging process can include a lower-temperature stage for about 70-80 minutes. For example, the lower-temperature stage can involve heating the panel to about 200-210 degrees Celsius for about 40-50 minutes. The pre-aging stage can optionally end with another stage of natural aging without applied heat. After the higher-temperature stage and the pre-aging stage, the panel can be subjected to assembly and paint bake cycles.

Multiple different materials can be used, including but not limited to an aluminum alloy. The choice of material and/or the specifics of the hot-stamping process can affect material properties such as strength, elongation and/or ductility. In some implementations, the stamped panel can be made using 6xxx series aluminum alloy. For example, the aluminum alloy can include:
about 0.40-1.00% manganese (Mn),
about 0.0-0.50% iron (Fe),
about 0.60-1.20% magnesium (Mg),
about 0.70-1.30% silicon (Si),
about 0.0-0.10% copper (Cu),
about 0.0-0.20% zinc (Zn),
about 0.0-0.10% titanium (Ti),
about 0.0-0.25% chromium (Cr),
about 0.0-0.15% residual material(s), and
a balance of aluminum.

The stamped panel 102 has a series 110 of ridges 110-1, 110-2, . . . , 110-n, where n=2, 3, . . . . The ridges 110-1, 110-2, . . . , 110-n are formed by stamping. Each of the ridges 110-1, 110-2, . . . , 110-n extends substantially perpendicular to the longitudinal axis of the stamped panel 102. As such, each of the ridges 110-1, 110-2, . . . , 110-n can be configured for axial crushing along a direction 112. For example, the direction 112 corresponds to a longitudinal axis of the respective one of the ridges 110-1, 110-2, . . . , 110-n. The geometry of such structural design(s) can provide the energy absorption side structure 100 with improved energy absorption characteristics.

The series 110 can include one or more groups of the ridges 110-1, 110-2, . . . , 110-n. Here, the series 110 has a group 110A that includes ridges 110-1, 110-2, . . . , 110-i, and a group 110B that includes ridges 110-j, . . . , 110-n. The ridges 110-1, 110-2, . . . , 110-i in the group 110A can have heights different from each other. A height 114 can be defined between a top part of the ridge and an intermediate-height area 116 that extends between the respective pairs of the ridges 110-1, 110-2, . . . , 110-i. That is, the ridges 110-1, 110-2, . . . , 110-i can be separated from each other by the intermediate-height area 116. The height 114 of the individual ridges can increase and/or decrease along the series 110.

One or more of the ridges 110-1, 110-2, . . . , 110-n can have an incline along its longitudinal axis. For example, the ridge(s) can be wedge shaped. The incline can be different in at least one of the ridges 110-1, 110-2, . . . , 110-n than in another one of the ridges. In some implementations, the ridges in the group 110B can have a different incline along their respective longitudinal axes than do the ridges in the group 110A. For example, the group 110B can have steeper inclines than do the ridges in the group 110A.

The stamped panel 102 can have at least one lowest-height section 118 whose height is lower than each of the ridges 110-1, 110-2, . . . , 110-n and is lower than the intermediate-height area 116. For example, the lowest-height section 118 can be positioned between the groups 110A and 110B.

The stamped panel 102 can have a wedge-shaped ridge 120 at the front end 106. The wedge-shaped ridge 120 can be formed by stamping. The wedge-shaped ridge 120 can extend substantially parallel to the longitudinal axis of the stamped panel 102. The wedge-shaped ridge 120 can have a narrower end 120a proximate the front end 106 and a wider end 120b distal to the front end 106. For example, the wedge-shaped ridge 120 can provide advantages in case of small-overlap collisions involving the vehicle.

The stamped panel 102 can include one or more flanges 122 that are substantially parallel with the backup structure expected to receive load from the energy absorption side structure 100. For example, the flange(s) 122 is positioned on an innermost side of the stamped panel 102, substantially parallel to the individual longitudinal axes of the ridges 110-1, 110-2, . . . , 110-n. The stamped panel 102 can include one or more gaps 124 between any two of the flanges 122. The gap(s) 124 can represent an interruption in the otherwise continuous surface formed by the flanges 122. For example, the gap(s) 124 can facilitate fastening operations or other attachment operations in securing the energy absorption side structure 100 to the vehicle.

The energy absorption side structure 100 can have a flange 126 that is substantially parallel with the backup structure and extends on an outboard side substantially along an entire length of the stamped panel 102. The flange 126 can be formed by at least one of the stamped panels 102 or 104. Each of the ridges 110-1, 110-2, . . . , 110-n can terminate before the flange 126. For example, the flange 126 can provide advantages in case of a side collision between the vehicle and an object such as a pole.

The energy absorption side structure 100 can have a complex shape along the length of its longitudinal axis. In some implementations, the energy absorption side structure 100 can have a twisted shape. For example, in the present perspective, the stamped panel 104 can be relatively thinner at the front end 106 than at the rear end 108.

The above examples illustrate that an energy absorption side structure (e.g., the energy absorption side structure 100) can include a first stamped panel (e.g., the stamped panel 102) having a series (e.g., the series 110) of first ridges (e.g., the ridges 110-1, 110-2, . . . , 110-n) each extending substantially perpendicular to a longitudinal axis of the first stamped panel. The energy absorption side structure can include a second stamped panel (e.g., the stamped panel 104) assembled to the first stamped panel to form an enclosed space extending substantially an entire length of the longitudinal axis. The energy absorption side structure can be configured for attachment to backup structure of the vehicle.

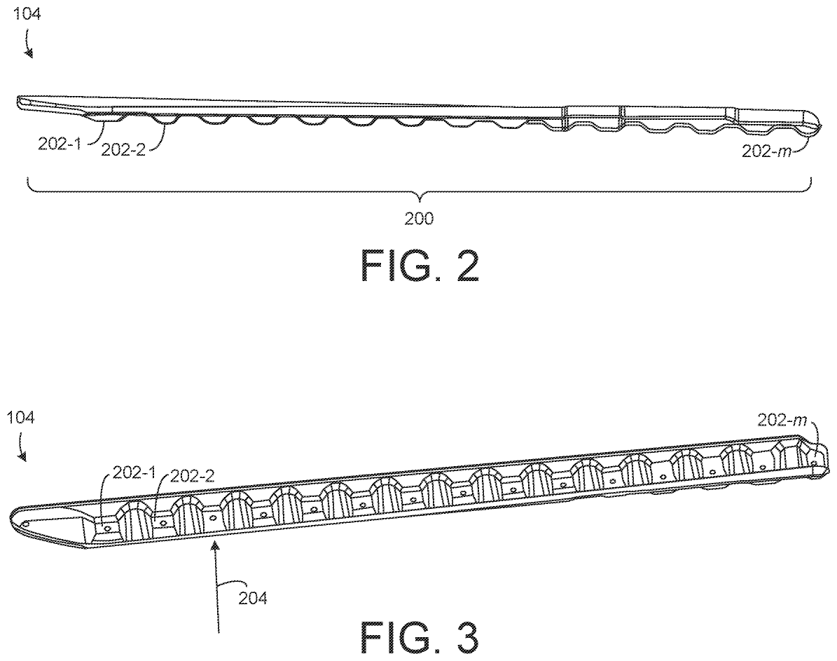

FIGS. 2-3 show examples of the stamped panel 104 of the energy absorption side structure 100 of FIG. 1. The stamped panel 104 can be used with one or more other examples described elsewhere herein. FIG. 2 shows a side view, and FIG. 3 a perspective view of the inside, of the stamped panel 104.

The stamped panel 104 has a series 200 of ridges 202-1, 202-2, . . . , 202-m, where m=2, 3, . . . . The ridges 202-1, 202-2, . . . , 202-m are formed by stamping. Each of the ridges 202-1, 202-2, . . . , 202-m extends substantially perpendicular to the longitudinal axis of the stamped panel 102. As such, each of the ridges 202-1, 202-2, . . . , 202-m can be configured for axial crushing along a direction 204. For example, the direction 204 corresponds to a longitudinal axis of the respective one of the ridges 202-1, 202-2, . . . , 202-m. The geometry of such structural design(s) can provide the energy absorption side structure 100 with improved energy absorption characteristics. Each of the ridges 202-1, 202-2, . . . , 202-m can have a different shape than the ridges 110-1, 110-2, . . . , 110-n of the stamped panel 102 in FIG. 1. The shape of the stamped panel 104 can facilitate a twisted shape of the energy absorption side structure 100, for example as shown in FIG. 1.

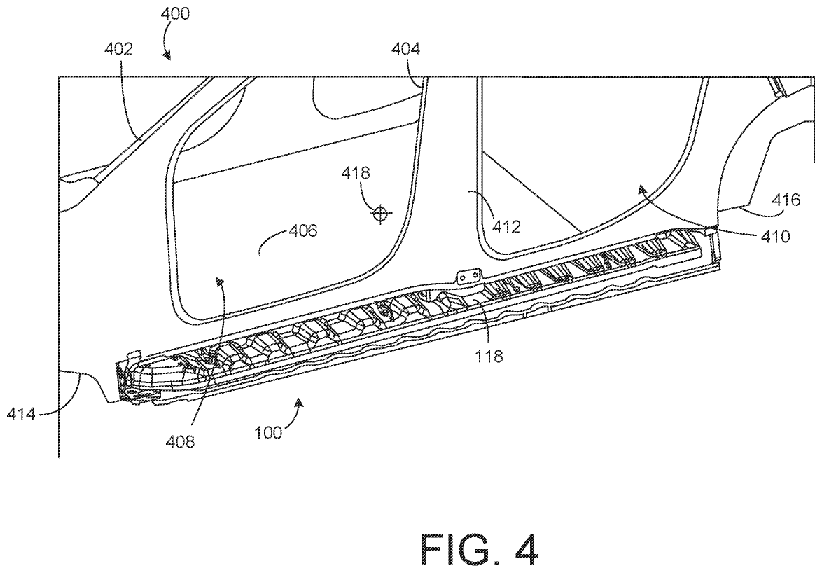

FIG. 4 partially shows an example of a vehicle body 400 with the energy absorption side structure 100 of FIG. 1. The vehicle body 400 can be used with one or more other examples described elsewhere herein. The vehicle body 400 can provide one or more backup structures for the energy absorption side structure 100. The vehicle body 400 can include an A-pillar 402 and a B-pillar 404. Inside the vehicle body 400 a floor 406 is formed. Only portions of the vehicle body 400 are shown for simplicity. The vehicle body 400 forms a door opening 408 (e.g., toward a first row of seats) and a door opening 410 (e.g., toward a second row of seats). Each of the door openings 408-410 is defined by material of the vehicle body 400. For example, such materials can include relatively large (stamped) panels sometimes referred to as a dooring inner. In some implementations, the hot-stamping process used for the stamped panels 102 and 104 (e.g., FIG. 1) of the energy absorption side structure 100 can also be used for the dooring inner(s) and/or for another component such as a B-pillar stiffener 412. For example, the B-pillar stiffener 412 can serve to stiffen the B-pillar 404 (e.g., to facilitate mounting one or more hinges for the rear door that closes the door opening 410).

The energy absorption side structure 100 can be positioned toward the outer edge of the vehicle body 400 generally between a wheel well 414 (e.g., for a front wheel) and a wheel well 416 (e.g., for a rear wheel). For example, the group 110A (FIG. 1) of ridges can be aligned with the door opening 408, and the group 110B (FIG. 1) of ridges can be aligned with the door opening 410. The vehicle can have a center of gravity 418. In some implementations, the group 110A can be positioned ahead of the center of gravity 418. For example, the heights (e.g., the height 114 in FIG. 1) of the group 110A of ridges can increase toward the center of gravity 418. The lowest-height section 118 can be aligned with the B-pillar 404.

The above examples illustrate that a vehicle can include a vehicle body (e.g., the vehicle body 400) providing a backup structure, and an energy absorption side structure (e.g., the energy absorption side structure 100). The energy absorption side structure can include the stamped panels 102 and 104 (FIG. 1).

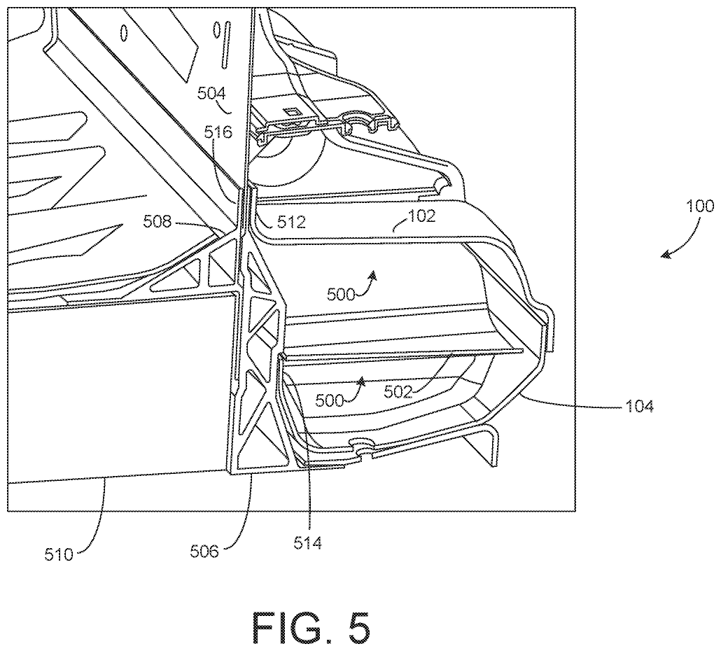

FIG. 5 shows an example cross section of the energy absorption side structure 100 of FIG. 1. The energy absorption side structure 100 includes the stamped panels 102 and 104 assembled together to form an enclosed space 500. The enclosed space 500 inside the energy absorption side structure 100 can be substantially separate from the outside. For example, the energy absorption side structure 100 can have one or more openings such that the enclosed space 500 is nevertheless largely separated from the outside. With reference again briefly to FIG. 1, the enclosed space 500 can have a greater height at the rear end 108 than at the front end 106. An intermediate stamped panel 502 can be positioned between the stamped panels 102-104 in the enclosed space 500. The vehicle can have a dooring inner 504. For example, the dooring inner 504 can be any of the stamped panels that define the door opening 408 or 410 (FIG. 4).

The vehicle can provide a backup structure for the energy absorption side structure 100. The backup structure can extend for substantially the entire length as the energy absorption side structure 100. The backup structure can include one or more components. In some implementations, the backup structure includes a sill extrusion 506. Either or both of the stamped panels 102 or 104 can be configured for attachment to the sill extrusion 506. The sill extrusion 506 can be configured for attachment to one or more other aspect of the backup structure. In some implementations, the backup structure comprises a first backup structure for the stamped panel 102, and a second backup structure for the stamped panel 104. For example, the first backup structure can include a midfloor extrusion 508 which can be one of the main rails of the vehicle's center underbody. As another example, the second backup structure can include a battery pack 510. The battery pack 510 is here schematically illustrated as a box and can include one or more types of storage for electric energy (including but not limited to, electrochemical cells). The stamped panel 102 can include a flange 512 abutting the backup structure (e.g., the sill extrusion 506). The stamped panel 104 can include a flange 514 abutting the backup structure (e.g., the sill extrusion 506). As such, the vehicle can provide at least partially different backup structure (e.g., the midfloor extrusion 508 versus the battery pack 510) for the stamped panels 102 and 104, respectively. At a location 516, this illustration exemplifies that a four-layer structure can be formed from the midfloor extrusion 508, the dooring inner 504, the sill extrusion 506, and the stamped panel 102, respectively. The gap(s) 124 (FIG. 1) can facilitate fastening or attachment (e.g., by way of rivets) that traverses fewer than all of the layers at the location 516.

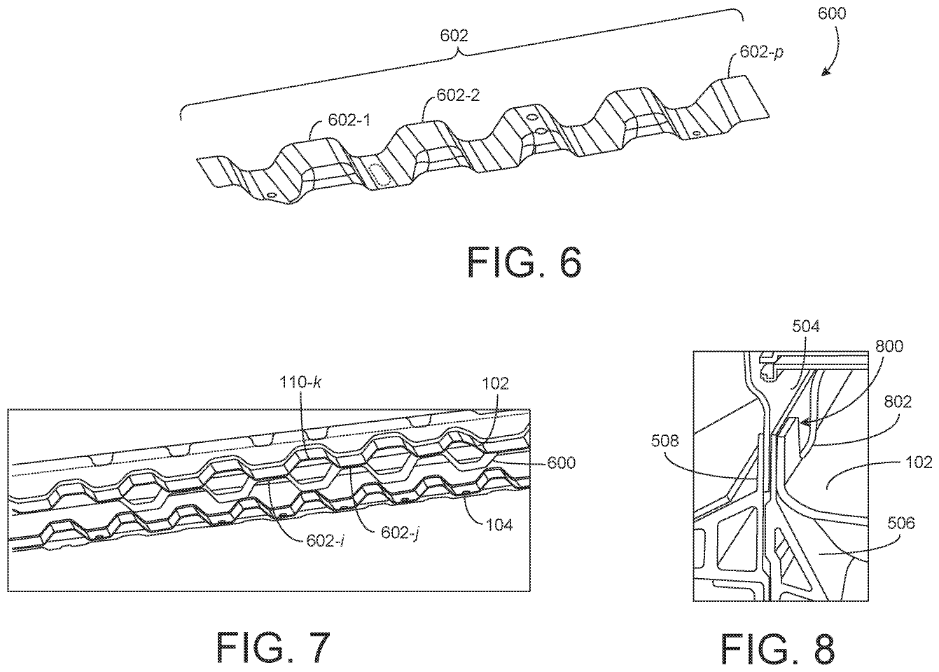

FIG. 6 shows an example of an intermediate stamped panel 600. The intermediate stamped panel 600 can be used with one or more other examples described elsewhere herein. The intermediate stamped panel 600 can be positioned between the stamped panels 102-104 in the enclosed space 500. For example, the intermediate stamped panel 600 can serve as the intermediate stamped panel 502 in FIG. 5. The intermediate stamped panel 600 can be formed by the same process as the stamped panels 102 or 104, or by a different process (e.g., another stamping or hot-stamping process).

The intermediate stamped panel 600 can have a series 602 of ridges 602-1, 602-2, . . . , 602-p, where p=2, 3, . . . . Each of the ridges 602-1, 602-2, . . . , 602-p can extend substantially perpendicular to a longitudinal axis of the intermediate stamped panel 600. The ridges 602-1, 602-2, . . . , 602-p can be substantially identical to at least some of the ridges 110-1, 110-2, . . . , 110-n.

FIG. 7 shows a partial cross section of an example of the intermediate stamped panel 600 of FIG. 6 positioned between the stamped panels 102 and 104 of the energy absorption side structure 100 of FIG. 1. Here, the intermediate stamped panel 600 has ridges 602-i and 602-j, among others. A ridge 110-k of the stamped panel 102 can be positioned directly between the ridges 602-i and 602-j.

FIG. 8 shows a partial view of an example of the energy absorption side structure 100 of FIG. 1 attached to the sill extrusion 506, the dooring inner 504, and the midfloor extrusion 508 of FIG. 5. At a location 800, a gap 802 in a flange of the stamped panel 102 provides a decreased-thickness material stack (e.g., three layers instead of four).

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. An energy absorption side structure for a vehicle, the energy absorption side structure comprising:
a first stamped panel having a series of first ridges each extending substantially perpendicular to a longitudinal axis of the first stamped panel; and
a second stamped panel assembled to the first stamped panel to form an enclosed space extending substantially an entire length of the longitudinal axis;
wherein the energy absorption side structure is configured for attachment to backup structure of the vehicle.

2. The energy absorption side structure of claim 1, wherein each of the first and second stamped panels includes a hot-stamped aluminum alloy.

3. The energy absorption side structure of claim 2, wherein the hot-stamped aluminum alloy includes:
about 0.40-1.00% Mn,
about 0.0-0.50% Fe,
about 0.60-1.20% Mg,
about 0.70-1.30% Si,
about 0.0-0.10% Cu,
about 0.0-0.20% Zn,
about 0.0-0.10% Ti,
about 0.0-0.25% Cr,
about 0.0-0.15% residual material(s), and
a balance of aluminum.

4. The energy absorption side structure of claim 1, wherein each of the series of first ridges is configured for axial crushing along a longitudinal axis of the respective first ridge.

5. The energy absorption side structure of claim 1, wherein the backup structure comprises a first backup structure for the first stamped panel, and a second backup structure for the second stamped panel, and wherein the first backup structure is different from the second backup structure.

6. The energy absorption side structure of claim 5, wherein the backup structure further comprises a sill extrusion, wherein each of the first and second stamped panels is configured for attachment to the sill extrusion, and wherein the sill extrusion is configured for attachment to the first and second backup structures.

7. The energy absorption side structure of claim 1, wherein the first stamped panel has a flange abutting the backup structure.

8. The energy absorption side structure of claim 1, wherein the second backup structure has a flange abutting the backup structure.

9. The energy absorption side structure of claim 1, wherein the energy absorption side structure has a front end and a rear end with regard to the vehicle, and wherein the enclosed space has a greater height at the rear end than at the front end.

10. The energy absorption side structure of claim 1, wherein at least a first group of the series of first ridges have heights different from each other.

11. The energy absorption side structure of claim 10, wherein the first group of the series of first ridges is positioned ahead of a center of gravity of the vehicle, and wherein the heights of the first group of the series of first ridges increase toward the center of gravity.

12. The energy absorption side structure of claim 11, wherein the first group of the series of first ridges is aligned with a front door opening of the vehicle.

13. The energy absorption side structure of claim 11, wherein a second group of the series of first ridges is aligned with a rear door opening of the vehicle.

14. The energy absorption side structure of claim 13, wherein each of the series of first ridges is wedge shaped, and wherein the second group of the series of first ridges has steeper inclines than the first group of the series of first ridges.

15. The energy absorption side structure of claim 10, wherein the first group of the series of first ridges are separated from each other by intermediate-height areas, each of the intermediate-height areas having a greater height than a lowest-height section of the first stamped panel.

16. The energy absorption side structure of claim 15, wherein the lowest-height section is aligned with a B-pillar of the vehicle.

17. The energy absorption side structure of claim 1, wherein the second stamped panel has a series of second ridges each extending substantially perpendicular to a longitudinal axis of the second stamped panel.

18. The energy absorption side structure of claim 17, wherein each of the series of second ridges has a different shape than the series of first ridges.

19. The energy absorption side structure of claim 1, wherein the first stamped panel includes a flange that is substantially parallel with the backup structure and extends on an outboard side substantially along an entire length of the first stamped panel, and wherein each of the first ridges terminates before the flange.

20. The energy absorption side structure of claim 1, further comprising an intermediate stamped panel positioned between the first and second stamped panels in the enclosed space.

21. The energy absorption side structure of claim 20, wherein the intermediate stamped panel has a series of second ridges each extending substantially perpendicular to a longitudinal axis of the intermediate stamped panel.

22. The energy absorption side structure of claim 20, wherein the second ridges are substantially identical to at least some of the first ridges.

23. The energy absorption side structure of claim 22, wherein the intermediate stamped panel is positioned so that one of the first ridges is positioned directly between two of the second ridges.

24. The energy absorption side structure of claim 1, wherein the first stamped panel further comprises a wedge-shaped ridge at a front end of the first stamped panel with regard to the vehicle, the wedge-shaped ridge extending substantially parallel to the longitudinal axis of the first stamped panel, and wherein the wedge-shaped ridge has a narrower end proximate the front end and a wider end distal to the front end.

25. A vehicle comprising:
a vehicle body providing a backup structure; and
an energy absorption side structure comprising:
a first stamped panel having a series of first ridges each extending substantially perpendicular to a longitudinal axis of the first stamped panel; and
a second stamped panel assembled to the first stamped panel to form an enclosed space extending substantially an entire length of the longitudinal axis;
wherein the backup structure supports the energy absorption side structure.

26. The vehicle of claim 25, further comprising a sill extrusion, wherein each of the first and second stamped panels is configured for attachment to the sill extrusion, and wherein the sill extrusion is configured for attachment to the backup structure.

27. The vehicle of claim 25, wherein the backup structure comprises a first backup structure for the first stamped panel, and a second backup structure for the second stamped panel, and wherein the first backup structure is different from the second backup structure.

28. The vehicle of claim 27, wherein the first backup structure comprises a floor structure of the vehicle.

29. The vehicle of claim 28, wherein the second backup structure comprises a battery pack of the vehicle.
